(19) United States
(12) Patent Application Publication
(10) Pub. No.: US 2014/0136823 A1
(43) Pub. Date: May 15, 2014

(54) Enabling A User And/Or Software To Dynamically Control Performance Tuning Of A Processor

(71) Applicants: Daniel J. Ragland, Hillsboro, OR (US); Nicholas J. Adams, Beaverton, OR (US); Ryan D. Wells, Folsom, CA (US)

(72) Inventors: Daniel J. Ragland, Hillsboro, OR (US); Nicholas J. Adams, Beaverton, OR (US); Ryan D. Wells, Folsom, CA (US)

(21) Appl. No.: 13/678,066

(22) Filed: Nov. 15, 2012

(51) Int. Cl. G06F 15/177

(52) U.S. Cl. 713/1

(57) ABSTRACT

In an embodiment, a processor includes a power control unit (PCU) to control power delivery to components of the processor and further including a storage having an overclock lock indicator which when set is to prevent a user from updating configuration settings associated with overclocking performance of the processor within an operating system (OS) environment. Other embodiments are described and claimed.

### BACKGROUND

Many computer users seek to maximize performance in a computer system. A familiar example is a so-called gamer who seeks to operate a system at high or extreme performance levels to enable a better gaming experience. To this end, some users will cause system components such as a processor and memory to be overclocked, that is, to operate at higher performance levels (such as frequency) than that specified by the manufacturer. Although this can lead to performance enhancement, such operation also reduces lifetime of the system, and can lead to catastrophic failure, particularly without the presence of an enhanced computer system design, including enhanced cooling system, voltage and current delivery mechanisms and so forth.

To reach these higher processing levels, typically an advanced user accesses certain settings within a pre-boot or basic input/output system (BIOS) environment, which requires the user to exit normal system operation, shut down and restart the system to enable entry into BIOS. This sequence can be time consuming and is undesirable for at least certain users, as it requires a good deal of knowledge to even determine the location of this control. Thus to make a performance change, a user exits an operating system, enters BIOS set up, makes a change to one or more settings in BIOS, reboots into an operating system (OS), and finally reloads the application/game desired. This process is slow and not user friendly, leading to an unsatisfactory user experience.

### BRIEF DESCRIPTION OF THE DRAWINGS

FIG. 1 is an illustration of a graphical user interface (GUI) available to a user in accordance with an embodiment of the present invention.

FIG. 2 is a flow diagram of a method for preventing a user from dynamically adjusting performance parameters of a platform in accordance with an embodiment of the present invention.

FIG. 3 is a flow diagram of a user-controlled configuration update method in accordance with an embodiment of the present invention.

FIG. 4 is an arrangement of a multi-platform system in accordance with an embodiment of the present invention.

FIG. 5 is a block diagram of a processor in accordance with an embodiment of the present invention.

FIG. 6 is a block diagram of a multi-domain processor in accordance with another embodiment of the present invention.

FIG. 7 is an embodiment of a processor including multiple cores is illustrated in accordance with an embodiment of the present invention.

FIG. 8 is a block diagram of a system in accordance with an embodiment of the present invention.

### DETAILED DESCRIPTION

In various embodiments, during normal system operation, namely outside of a pre-boot environment and within an operating system (OS) environment, a user can dynamically control various performance tuning knobs or configuration settings in real time. In this way, performance optimizations can be realized in real time within the OS environment such that changes take effect immediately, providing instant results. As such, the need for a user to access a pre-boot environment to effect changes to configuration settings (e.g., associated with processor performance) can be avoided. By managing overclocking in a dynamic fashion, risks such as potential system failures associated with overclocking can be reduced by transitioning into and out of out of specification modes in real-time on demand. In addition to user-based control of such settings, embodiments may further provide for automated updates to one or more configuration settings, e.g., via an OS or application executing under the OS, responsive to a type of application or other code being executed by the user.

Embodiments may be implemented in many different platforms, which can include a processor such as a multicore, multi-domain processor. As used herein the term “domain” is used to mean a collection of hardware and/or logic that operates at the same voltage and frequency point. As an example, a multicore processor can further include other non-core processing engines such as fixed function units, graphics engines, and so forth. Other computing elements can include digital signal processors, processor communications interconnects (buses, rings, etc.), and network processors. A processor can include multiple independent domains, including a first domain associated with the cores (referred to herein as a core or central processing unit (CPU) domain) and a second domain associated with a graphics engine (referred to herein as a graphics or a graphics processing unit (GPU) domain). Although many implementations of a multi-domain processor can be formed on a single semiconductor die, other implementations can be realized by a multi-chip package in which different domains can be present on different semiconductor die of a single package or multiple packages.

Although the scope of the present invention is not limited in this regard, in various embodiments configuration settings associated with processor performance that can be controlled include a core clock frequency, also referred to herein as a core clock ratio, in that an example processor may be controlled to operate at a frequency corresponding to a ratio between a core clock frequency and a base clock frequency (referred to herein as BCLK). Other configuration settings may include control of a graphics engine frequency, e.g., according to a graphics engine clock ratio, voltage for core and/or graphics engine, along with other power/thermal performance values. Collectively, control of one or more of these configuration settings to increase performance is referred to herein as overclocking.

In general overclocking theory seeks to maximize frequency and minimize voltage/current while removing as much heat as possible such that stability requirements are met. To enable extra overclocking, a higher air flow and/or more efficient heat sink and/or aggressive cooling (such as via liquid cooling) may be provided to the processor and voltage regulators. In this way the allowable power and current limits of the processor can be increased.

Since modifications to these configuration settings can adversely affect system lifetime and can even lead to catastrophic failures, embodiments may also provide a mechanism to enable a system manufacturer to prevent such user-controlled dynamic configuration changes, referred to herein as overclock locking, such that when enabled, a user is prevented from dynamically modifying these performance tunings.

Note that embodiments that perform overclocking as described herein may be independent of OS-based power management. For example, according to an OS-based mechanism, namely the Advanced Configuration and Platform Interface (ACPI) standard (e.g., Rev. 3.0b, published Oct. 10, 2006), a processor can operate at various performance states or levels, namely from P0 to PN. In general, the P1 performance state may correspond to the highest guaranteed performance state that can be requested by an OS. In addition to this P1 state, the OS can further request a higher performance state, namely a P0 state. This P0 state may thus be an opportunistic state in which, when power and/or thermal budget is available, processor hardware can configure the processor or at least portions thereof to operate at a higher than guaranteed frequency, also referred to as a turbo mode. In many implementations a processor can include multiple so-called bin frequencies above this P1 frequency. By enabling user controlled overclocking as described herein, embodiments enable turbo mode operation at higher than specified maximum operating frequencies. In addition, according to ACPI, a processor can operate at various power states or levels. With regard to power states, ACPI specifies different power consumption states, generally referred to as C-states, C0, C1 to Cn states. When a core is active, it runs at a C0 state, and when the core is idle it may be placed in a core low power state, also called a core non-zero C-state (e.g., C1-C6 states). When all cores of a multicore processor are in a core low power state, the processor can be placed in a package low power state, such as a package C6 low power state.

Embodiments may provide a communication interface between the processor and a device driver and application layers of the operating system. This interface allows users or authorized applications to effect changes to standard or default power/performance algorithms used by the processor. In one embodiment a power control unit (PCU) of a processor executes microcode stored in the processor. This microcode contains instructions that govern the power and performance modes of the system. Under normal circumstances the PCU operates autonomously with predefined tuning parameters. Via a communications mechanism in accordance with an embodiment of the present invention, user or application defined parameters regarding various processor performance can be dynamically updated. Specifically, structures including memory mapped input/output (MMIO) mail boxes and machine specific registers (MSR's) are exposed to an OS driver and then to application layers. A software implementation such as a utility can be given access to the structures to make adjustments to configuration settings in processor structures. Once these structures are updated, the PCU recognizes the change and the performance characteristics are changed in real-time (with no reboot).

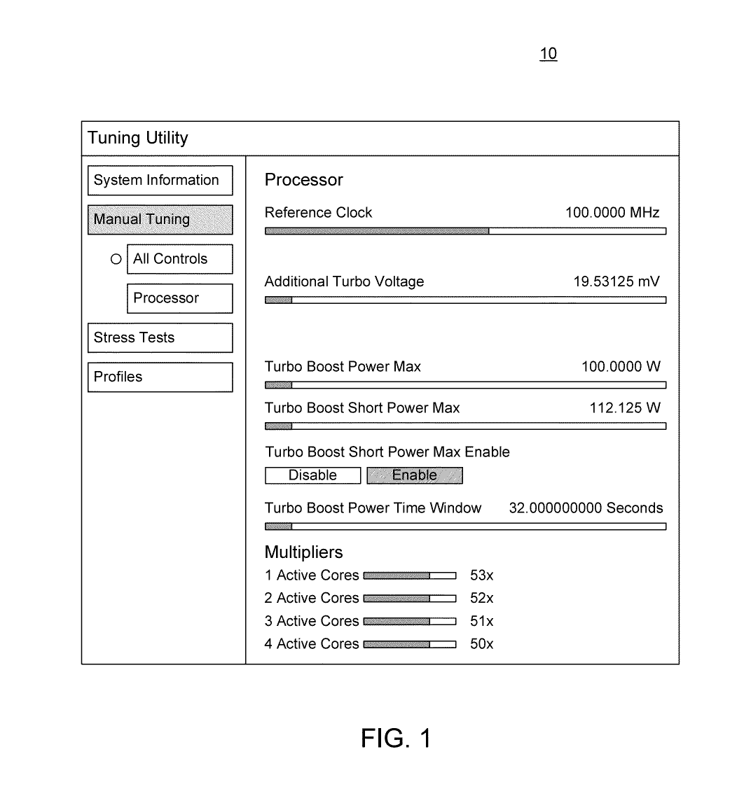

Referring now to FIG. 1, shown is an illustration of a graphical user interface (GUI) available to a user, e.g., via an application that can be downloaded from a processor manufacturer, a system manufacturer or a third party, to enable real time (OS environment) performance tuning of platform features, including both processor-based features as well as other platform features. In the illustration shown, GUI 10 enables a plurality of performance or configuration settings to be dynamically adjusted by the user. In the embodiment shown, these settings include a maximum core clock ratio, a maximum graphics clock ratio, power limits, including a so-called power limit 1 (PL1) which is a long term power limit, a power limit 2 (PL2) which is a short term power limit, and a Tau value which is a variable for a time constant that affects the sampling of power, as well as an available voltage for so-called turbo mode for core and graphics units.

As another example a maximum current (Icc max) can be changed to increase maximum Icc for both core and graphics units when in turbo mode, such that a phase locked loop (PLL) overvoltage increases an internal processor voltage regulator to allow additional frequency scaling on a series of PLLs that manage frequency within the processor.

In an example embodiment controllable multipliers may be provided for core frequency with unlocked turbo limits to provide unlocked core ratios up to 63 in 100 megahertz (MHz) increments, and also provides a programmable voltage offset (which may provide an increased voltage of between approximately 1.0 and 1.52 volts). Graphics frequency with unlocked graphics turbo limits provides unlocked graphics ratios up to 60 in 50 MHz increments, and a programmable voltage offset. Also, in some embodiments an update to increase the BCLK via this GUI can change several of these subsystem frequencies at once. Select voltages can be adapted to support frequency on each interface impacted. Although shown with these particular configuration settings in the illustration of FIG. 1, understand the scope of the present invention is not limited in this regard.

For example, the above described configuration settings are for a processor package. Other system parameters can similarly be dynamically controlled by a user during runtime. Still further, via a GUI such as GUI 10, additional information can be provided to a user. For example, various monitoring of processor conditions such as temperature, utilization, frequency, thermal design power (TDP), among many other parameters can be displayed in real time to a user, e.g., via a graphical presentation of the information. A tuning utility, in addition to providing an interface for receiving tuning parameters, can also perform stress tests by applying application/workload stress on the processor at an updated frequency after a change is effected. Also, a mechanism can be provided to enable a user to apply changes and save them into a profile, such that multiple profiles can be stored, e.g., in a non-volatile storage of a system. This profile storage can enable the user to recall these profiles, e.g., upon a different execution of an application such as a particular gaming application for which the user has set a group of configuration settings.

As described above, dynamic runtime changes to processor performance settings can be effected by a user or automated software/firmware. Certain manufacturers, such as those selling high-end stable systems may not want their platforms to be able to change performance settings outside of a pre-boot environment. As such, embodiments may further provide a mechanism to prevent a real-time user-controlled change to performance settings. In one embodiment, a configuration parameter, e.g., a bit of a configuration register such as a MSR within a processor can be set to prevent dynamic user performance setting changes. Generally, such settings are referred to herein as overclocking settings and as such, this indicator may be referred to as an overclocking lock indicator. In one embodiment, this indicator may correspond to a field such as a one bit field of an MSR such as a power management MSR, e.g., located within a PCU of the processor. Understand the scope of the present invention is not limited in this regard, and this overclocking lock indicator can be located in other registers or storages of a processor. Also, by providing an overclocking lock indicator, malicious activity such as malicious code can be avoided, to protect against reverse engineering a tuning utility to determine what registers are changing.

In operation, dynamic changing of configuration settings are prevented, in that processor microcode or other such logic that receives a request for a user-controlled dynamic configuration change will disallow the change to be effected responsive to this set overclocking indicator. Of course the scope of the present invention is not limited in this aspect and other mechanisms to prevent a user from dynamic overclocking of a platform can be realized. For example an overclocking lock indicator may be associated with each register or other storage that stores processor performance configuration settings instead of a single global lock bit to lock all overlocking parameters collectively.

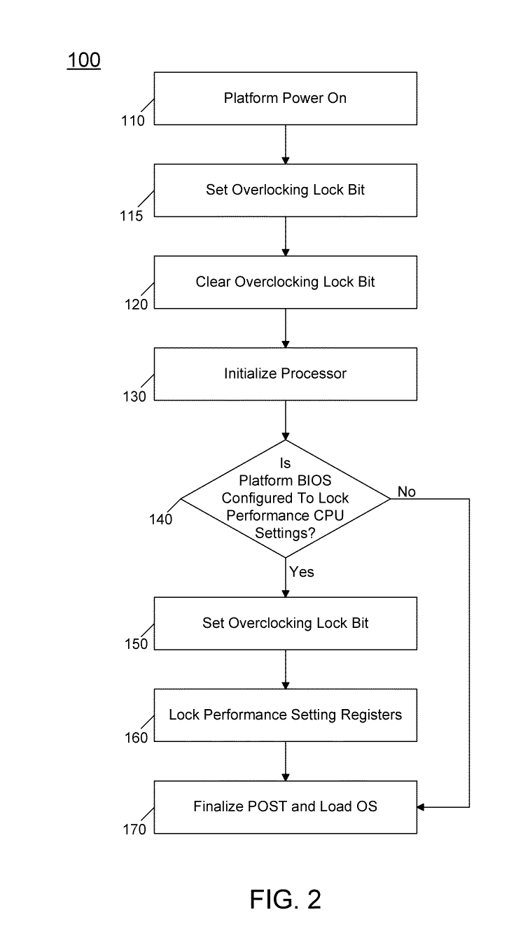

Referring now to FIG. 2, shown is a flow diagram of a method for dynamically preventing a user from overclocking a platform in accordance with an embodiment of the present invention. As shown in FIG. 2, method 100 may begin when a platform powers on (block 110). As an example, a platform is configured to power on into a pre-boot, e.g., BIOS environment. Next control passes to block 120 where an overclocking lock indicator can be cleared, if it is set. Note that this clearing of the overclocking lock indicator may be performed early within a BIOS sequence, such as during a power on self test (POST) or other early BIOS sequence that is not user accessible. Then control passes to block 130 where initialization of the processor within a BIOS routine can be performed. In an embodiment, the overclocking lock indicator is by default locked and if a given manufacturer wants to unlock it, a given BIOS code explicitly sets the indicator to unlock it, within a short period of time early in POST. And if that time window is missed it is too late in that boot to enable user-controlled dynamic overclocking. As such, malicious code is prevented from hijacking the mechanism described herein for attacking a system.

Still referring to FIG. 2, next it can be determined whether a platform's BIOS is configured to prevent dynamic control of overclocking, as where a manufacturer, e.g., a platform manufacturer such as an original equipment manufacturer (OEM) or an original device manufacturer (ODM), seeks to prevent such updates (diamond 140). If so, control passes to block 150 where the overclocking lock indicator can be set. Note that this setting can be performed during BIOS execution. Although shown in FIG. 2 as a single indicator (e.g., bit), understand that a given indicator may be associated with each configuration setting that can be controlled in real time. During BIOS, note that certain microcode of the processor such as so-called power control code (or P-code) may execute. Accordingly at block 160 various performance configuration settings such as maximum frequency setting, maximum voltage setting, maximum current setting and so forth stored in corresponding configuration registers can be locked responsive to this overclocking lock indicator. In an embodiment, these registers can be locked for system operation by preventing user access or updates to the registers. Finally, control passes to block 170 where POST can be finalized and a pre-boot environment completed. Control thus passes to a boot environment where an OS is loaded and normal system operation begins.

If instead the manufacturer does not seek to lock out dynamic overclocking control, control passes from diamond 140 to block 170 directly. As such, the platform is enabled for user controlled dynamic configuration setting updates as described herein. Although shown at this high level in the embodiment of FIG. 2, understand the scope of the present invention is not limited in this regard.

As described above, embodiments may also provide for an automatic dynamic update to the configuration settings based on actual system operation. For example, in some embodiments, an OS can monitor a type of workload, e.g., application being executed, and trigger requests to update one or more configuration settings. As an example, the OS can cause a core clock frequency to be increased when a first application (e.g., a game is executing and cause the core clock frequency to be decreased when a second application (e.g., a web browser) is executing.

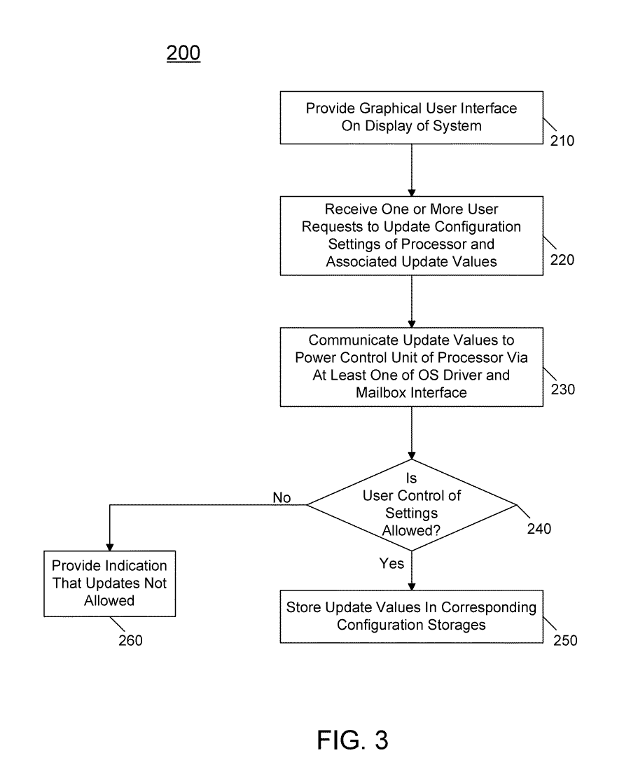

Referring now to FIG. 3, shown is a flow diagram of a user-controlled configuration update method in accordance with an embodiment of the present invention. As shown in FIG. 3, method 200 may be performed by a combination of components that receive user input and determine whether one or more configuration setting updates based on such input is allowed.

In the embodiment shown in FIG. 3, method 200 may begin by providing a graphical user interface on a display of a system (block 210). For example, a user can open an application, e.g., downloaded via the Internet, configured on a system as a utility application or otherwise stored into a program storage of the system. This application may thus provide this GUI display which can be of the form in FIG. 1 above or in any other manner to seek user input for one or more configuration settings. Note in still further embodiments, this GUI can be provided via a cloud-based solution such as accessible via a website of a processor manufacturer or platform provider such as an OEM that makes available this user display to seek input of user information.

Regardless of the manner in which the interface is displayed, method 200 continues to block 220 where one or more user requests to update a configuration setting of the processor can be received along with associated update values. For purposes of discussion assume that a single configuration setting, namely a core clock ratio is requested to be updated. Such request can be effected via a user selecting this setting, e.g., via a click and further input of an updated value for the setting, e.g., by click of a mouse to increase this value via a bar, or via input of a number by keyboard or in any other manner.

Still referring to FIG. 3, next control passes to block 230 where these one or more updated values can be communicated to a power control unit of a processor via at least one of an OS driver and a mailbox interface. For example, as discussed above an OS driver can be used to communicate values to a PCU that relate to a processor core and other features of a processor. Instead for configuration settings relating to a graphics engine within the processor, in some embodiments a mailbox interface may be used to communicate these values. In any event, the updated values are thus communicated to the PCU.

Still referring to FIG. 3, next at diamond 240 the PCU can determine whether user control of the settings is allowed. In an embodiment, this determination may be made via reference to one or more overclocking lock indicators as discussed above. If the user control is allowed, control passes to block 250 where the updated values can be stored in corresponding configuration storages such as one or more configuration registers accessible to the PCU. In the particular example described, a maximum core clock ratio register can be updated with this new value. As such, when the PCU next executes its P-code or other power control management operations, this updated value can be used in the analysis and determination of an appropriate processor frequency such that the change takes effect in real time and without a re-boot.

Otherwise, if it is determined at diamond 240 that user control of the configuration settings is not allowed, control passes instead to block 260 where no change is effected and instead an indication may be provided that such updates are not allowed. As an example, a display indication can be made to the user to indicate that these updated values are not allowed. Although described with this implementation in the embodiment of FIG. 3, understand the scope of the present invention is not limited in this regard. For example, in other embodiments the determination of whether user control is allowed may be on a per setting basis such that a corresponding overclocking lock indicator can be associated with each such setting and thus method 200 may be iterated for each of multiple update values received from a user.

In some embodiments, performance monitoring and tuning of a platform can be realized using smartphones, tablets or other second systems, e.g., utilizing a wireless connection. This interface enables a tuning utility executing on the target platform to control various parameters, monitor system status, e.g., processor utilization, frequencies, temperature, and system statistics even when a user is immersed in a full screen activity, and to communicate the information for display on a second system.

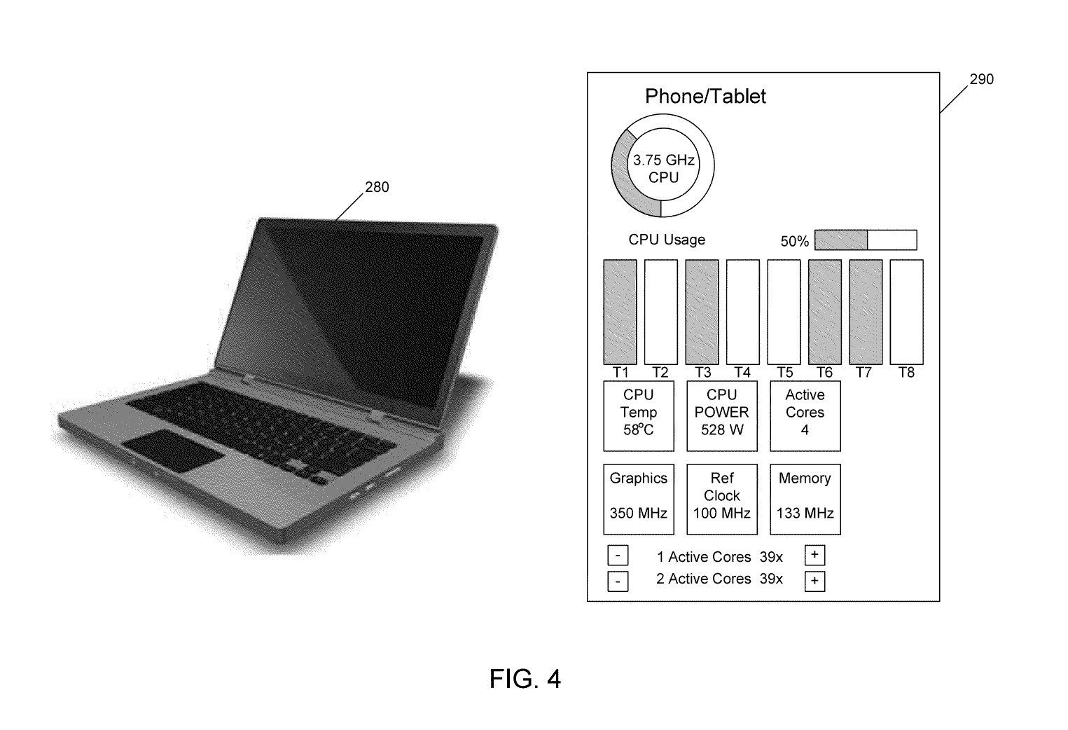

Referring now to FIG. 4, shown is an arrangement of a multi-platform system that can take advantage of user controlled performance settings in accordance with an embodiment of the present invention. As shown in FIG. 4, a first system 280, which in the implementation shown is a laptop may be designed to be placed into an overclocking state, e.g., during execution of a gaming application. In addition, system 290 can include and execute a performance tuning utility as described above. However, during gaming execution, a user may be fully immersed, and a full screen of the display may be consumed by the gaming application. As such, it becomes difficult for the user to access this performance tuning utility in real time. Accordingly, embodiments may provide an ability for an additional system, such as a smartphone, tablet computer or any other type of system to similarly include a performance tuning utility that can be used in connection with platform 280.

Thus in the embodiment shown in FIG. 4, a second system 290 similarly includes a performance tuning utility, as displayed on its display. As such, by this second system, a user can dynamically effect changes, which can be communicated from second system 290 to first system 280 via any data communication means, such as via a wireless connection, e.g., a wireless local area network (WLAN). As such, the active performance tuning utility on first system 280 may execute in the background to receive changes and to perform the operations described herein to enable those changes to take effect. In addition, performance monitoring can be realized by this second system 290 in a generally opposite direction such that performance monitoring information, e.g., as available within the performance tuning utility can be communicated from first system 280 to second system 290 for display on a display of that system. Understand that many variations are possible, and the illustrated platforms can take many different forms in different embodiments.

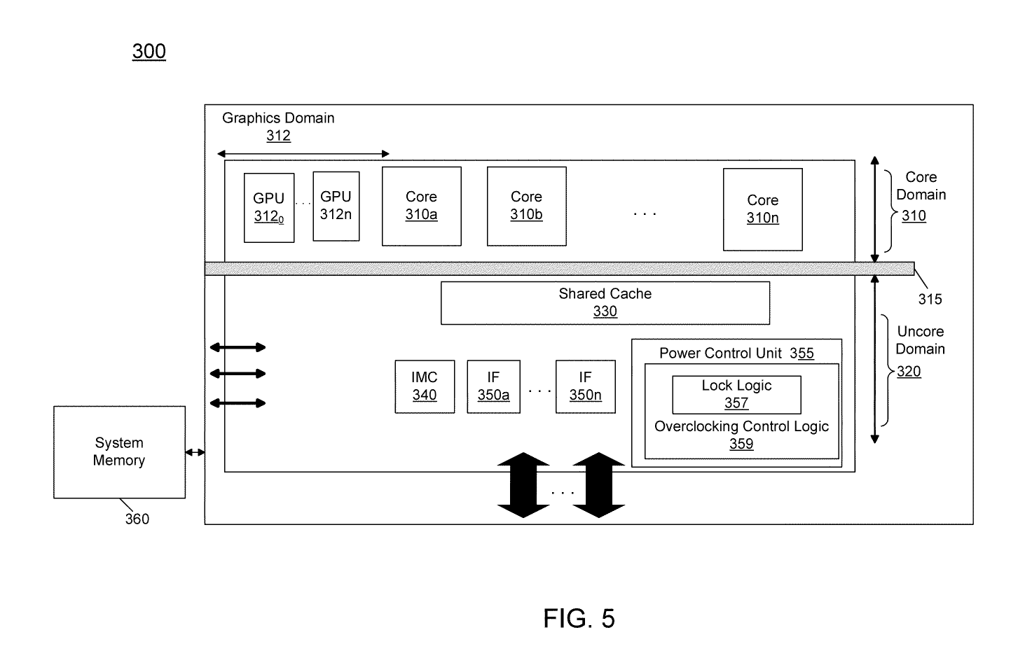

Referring now to FIG. 5, shown is a block diagram of a processor in accordance with an embodiment of the present invention. As shown in FIG. 5, processor 300 may be a multicore processor including a plurality of cores 310ₐ-310ₙ in a core domain 310. In one embodiment, each such core may be of an independent power domain and can be configured to operate at an independent voltage and/or frequency, and to enter turbo mode when available headroom exists, or the cores can be uniformly controlled as a single domain. As further shown in FIG. 5, one or more GPUs 312₀-312ₙ may be present in a graphics domain 312. Each of these independent graphics engines also may be configured to operate at independent voltage and/or frequency or may be controlled together as a single domain. These various compute elements may be coupled via an interconnect 315 to a system agent or uncore 320 that includes various components. As seen, the uncore 320 may include a shared cache 330 which may be a last level cache. In addition, the uncore may include an integrated memory controller 340, various interfaces 350 and a power control unit 355.

In various embodiments, power control unit 355 may include a power sharing logic 359, which may be a logic to control of one or more domains of the processor to be overlocked to enable greater performance than available according to specified maximum performance level. In the embodiment of FIG. 5, overclocking control logic 359 may include a lock logic 357 to determine based on an overclocking lock indicator as to whether a dynamic user update request within an OS environment is permitted to be effected. Although shown at this location in the embodiment of FIG. 5, understand that the scope of the present invention is not limited in this regard and the storage of this logic can be in other locations.

With further reference to FIG. 5, processor 300 may communicate with a system memory 360, e.g., via a memory bus. In addition, by interfaces 350, connection can be made to various off-chip components such as peripheral devices, mass storage and so forth. While shown with this particular implementation in the embodiment of FIG. 5, the scope of the present invention is not limited in this regard.

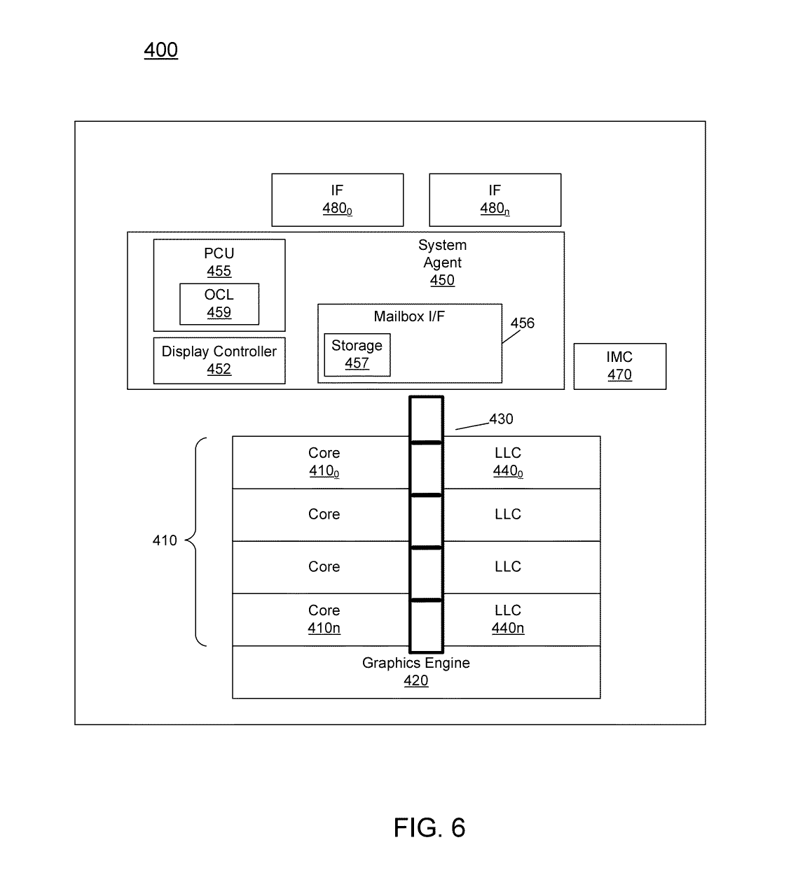

Referring now to FIG. 6, shown is a block diagram of a multi-domain processor in accordance with another embodiment of the present invention. As shown in the embodiment of FIG. 6, processor 400 includes multiple domains. Specifically, a core domain 410 can include a plurality of cores 410₀-410ₙ, a graphics domain 420 can include one or more graphics engines, and a system agent domain 450 may further be present. In various embodiments, system agent domain 450 may execute at a fixed frequency and may remain powered on at all times to handle power control events and power management such that domains 410 and 420 can be controlled to dynamically enter into and exit low power states as well as overclocking states as described herein. Each of domains 410 and 420 may operate at different voltage and/or power.

Note that while only shown with three domains, understand the scope of the present invention is not limited in this regard and additional domains can be present in other embodiments. For example, multiple core domains may be present each including at least one core.

In general, each core 410 may further include low level caches in addition to various execution units and additional processing elements. In turn, the various cores may be coupled to each other and to a shared cache memory formed of a plurality of units of a last level cache (LLC) 440₀-440ₙ. In various embodiments, LLC 440 may be shared amongst the cores and the graphics engine, as well as various media processing circuitry. As seen, a ring interconnect 430 thus couples the cores together, and provides interconnection between the cores, graphics domain 420 and system agent circuitry 450.

In the embodiment of FIG. 6, system agent domain 450 may include display controller 452 which may provide control of and an interface to an associated display, which can be used to display a GUI of a tuning utility as described herein. As further seen, system agent domain 450 may include a power control unit 455 which can include an overclocking control logic 459 in accordance with an embodiment of the present invention to handle overclocking control, including the real time user controlled overclocking described herein.

To enable communication of at least certain of the user updates, a mailbox interface 456 can be present. In general, interface 456 can include a storage 457. This storage can store user inputs regarding at least some of the updated values and provide an interface for handshake-based communications between the PCU and other domains. In one embodiment, PCU 455 can receive updates to the graphics engine configuration settings via this mailbox interface. While described with this particular protocol in the embodiment of FIG. 6, understand the scope of the present invention is not limited in this regard.

As further seen in FIG. 6, processor 400 can further include an integrated memory controller (IMC) 470 that can provide for an interface to a system memory, such as a dynamic random access memory (DRAM). Multiple interfaces 480₀-480ₙ may be present to enable interconnection between the processor and other circuitry. For example, in one embodiment at least one direct media interface (DMI) interface may be provided as well as one or more Peripheral Component Interconnect Express (PCI Express™ (PCIe™)) interfaces. Still further, to provide for communications between other agents such as additional processors or other circuitry, one or more interfaces in accordance with an Intel® Quick Path Interconnect (QPI) protocol may also be provided. Although shown at this high level in the embodiment of FIG. 6, understand the scope of the present invention is not limited in this regard.

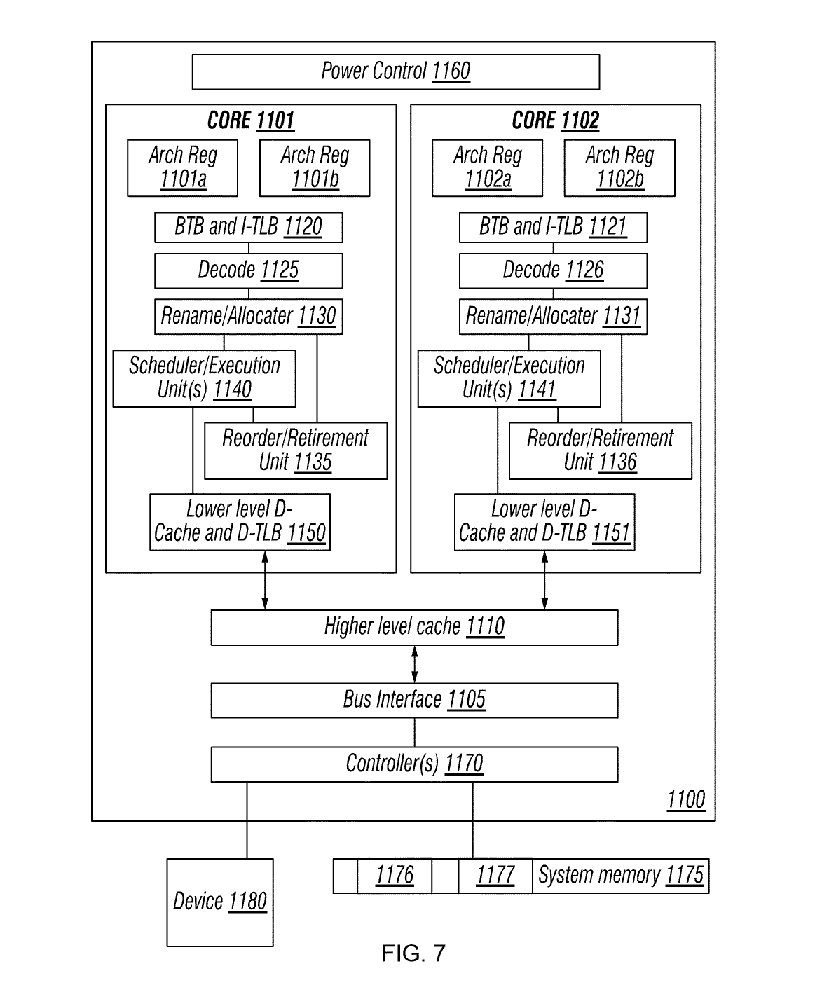

Referring to FIG. 7, an embodiment of a processor including multiple cores is illustrated. Processor 1100 includes any processor or processing device, such as a microprocessor, an embedded processor, a digital signal processor (DSP), a network processor, a handheld processor, an application processor, a co-processor, a system on a chip (SOC), or other device to execute code. Processor 1100, in one embodiment, includes at least two cores—cores 1101 and 1102, which may include asymmetric cores or symmetric cores (the illustrated embodiment). However, processor 1100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1100, as illustrated in FIG. 7, includes two cores, cores 1101 and 1102. Here, cores 1101 and 1102 are considered symmetric cores, i.e., cores with the same configurations, functional units, and/or logic. In another embodiment, core 1101 includes an out-of-order processor core, while core 1102 includes an in-order processor core. However, cores 1101 and 1102 may be individually selected from any type of core, such as a native core, a software managed core, a core adapted to execute a native instruction set architecture (ISA), a core adapted to execute a translated ISA, a co-designed core, or other known core. Yet to further the discussion, the functional units illustrated in core 1101 are described in further detail below, as the units in core 1102 operate in a similar manner.

As depicted, core 1101 includes two hardware threads 1101a and 1101b, which may also be referred to as hardware thread slots 1101a and 1101b. Therefore, software entities, such as an operating system, in one embodiment potentially view processor 1100 as four separate processors, i.e., four logical processors or processing elements capable of executing four software threads concurrently. As alluded to above, a first thread is associated with architecture state registers 1101a, a second thread is associated with architecture state registers 1101b, a third thread may be associated with architecture state registers 1102a, and a fourth thread may be associated with architecture state registers 1102b. Here, each of the architecture state registers (1101a, 1101b, 1102a, and 1102b) may be referred to as processing elements, thread slots, or thread units, as described above. As illustrated, architecture state registers 1101a are replicated in architecture state registers 1101b, so individual architecture states/contexts are capable of being stored for logical processor 1101a and logical processor 1101b. In core 1101, other smaller resources, such as instruction pointers and renaming logic in allocator and renamer block 1130 may also be replicated for threads 1101a and 1101b. Some resources, such as re-order buffers in reorder/retirement unit 1135, ILTB 1120, load/store buffers, and queues may be shared through partitioning. Other resources, such as general purpose internal registers, page-table base register(s), low-level data-cache and data-TLB 1115, execution unit(s) 1140, and portions of out-of-order unit 1135 are potentially fully shared.

Processor 1100 often includes other resources, which may be fully shared, shared through partitioning, or dedicated by/to processing elements. In FIG. 7, an embodiment of a purely exemplary processor with illustrative logical units/resources of a processor is illustrated. Note that a processor may include, or omit, any of these functional units, as well as include any other known functional units, logic, or firmware not depicted. As illustrated, core 1101 includes a simplified, representative out-of-order (OOO) processor core. But an in-order processor may be utilized in different embodiments. The OOO core includes a branch target buffer 1120 to predict branches to be executed/taken and an instruction-translation buffer (I-TLB) 1120 to store address translation entries for instructions.

Core 1101 further includes decode module 1125 coupled to fetch unit 1120 to decode fetched elements. Fetch logic, in one embodiment, includes individual sequencers associated with thread slots 1101a, 1101b, respectively. Usually core 1101 is associated with a first ISA, which defines/specifies instructions executable on processor 1100. Often machine code instructions that are part of the first ISA include a portion of the instruction (referred to as an opcode), which references/specifies an instruction or operation to be performed. Decode logic 1125 includes circuitry that recognizes these instructions from their opcodes and passes the decoded instructions on in the pipeline for processing as defined by the first ISA. For example, decoders 1125, in one embodiment, include logic designed or adapted to recognize specific instructions, such as transactional instruction. As a result of the recognition by decoders 1125, the architecture or core 1101 takes specific, predefined actions to perform tasks associated with the appropriate instruction. It is important to note that any of the tasks, blocks, operations, and methods described herein may be performed in response to a single or multiple instructions; some of which may be new or old instructions.

In one example, allocator and renamer block 1130 includes an allocator to reserve resources, such as register files to store instruction processing results. However, threads 1101a and 1101b are potentially capable of out-of-order execution, where allocator and renamer block 1130 also reserves other resources, such as reorder buffers to track instruction results. Unit 1130 may also include a register renamer to rename program/instruction reference registers to other registers internal to processor 1100. Reorder/retirement unit 1135 includes components, such as the reorder buffers mentioned above, load buffers, and store buffers, to support out-of-order execution and later in-order retirement of instructions executed out-of-order.

Scheduler and execution unit(s) block 1140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1150 are coupled to execution unit(s) 1140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1101 and 1102 share access to higher-level or further-out cache 1110, which is to cache recently fetched elements. Note that higher-level or further-out refers to cache levels increasing or getting further away from the execution unit(s). In one embodiment, higher-level cache 1110 is a last-level data cache—last cache in the memory hierarchy on processor 1100—such as a second or third level data cache. However, higher level cache 1110 is not so limited, as it may be associated with or includes an instruction cache. A trace cache—a type of instruction cache—instead may be coupled after decoder 1125 to store recently decoded traces.

In the depicted configuration, processor 1100 also includes bus interface module 1105 and a power controller 1160, which may perform power sharing control in accordance with an embodiment of the present invention. Historically, controller 1170 has been included in a computing system external to processor 1100. In this scenario, bus interface 1105 is to communicate with devices external to processor 1100, such as system memory 1175, a chipset (often including a memory controller hub to connect to memory 1175 and an I/O controller hub to connect peripheral devices), a memory controller hub, a northbridge, or other integrated circuit. And in this scenario, bus 1105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1175 may be dedicated to processor 1100 or shared with other devices in a system. Common examples of types of memory 1175 include DRAM, SRAM, non-volatile memory (NV memory), and other known storage devices. Note that device 1180 may include a graphic accelerator, processor or card coupled to a memory controller hub, data storage coupled to an I/O controller hub, a wireless transceiver, a flash device, an audio controller, a network controller, or other known device.

Note however, that in the depicted embodiment, the controller 1170 is illustrated as part of processor 1100. Recently, as more logic and devices are being integrated on a single die, such as SOC, each of these devices may be incorporated on processor 1100. For example in one embodiment, memory controller hub 1170 is on the same package and/or die with processor 1100. Here, a portion of the core (an on-core portion) includes one or more controller(s) 1170 for interfacing with other devices such as memory 1175 or a graphics device 1180. The configuration including an interconnect and controllers for interfacing with such devices is often referred to as an on-core (or un-core configuration). As an example, bus interface 1105 includes a ring interconnect with a memory controller for interfacing with memory 1175 and a graphics controller for interfacing with graphics processor 1180. Yet, in the SOC environment, even more devices, such as the network interface, co-processors, memory 1175, graphics processor 1180, and any other known computer devices/interface may be integrated on a single die or integrated circuit to provide small form factor with high functionality and low power consumption.

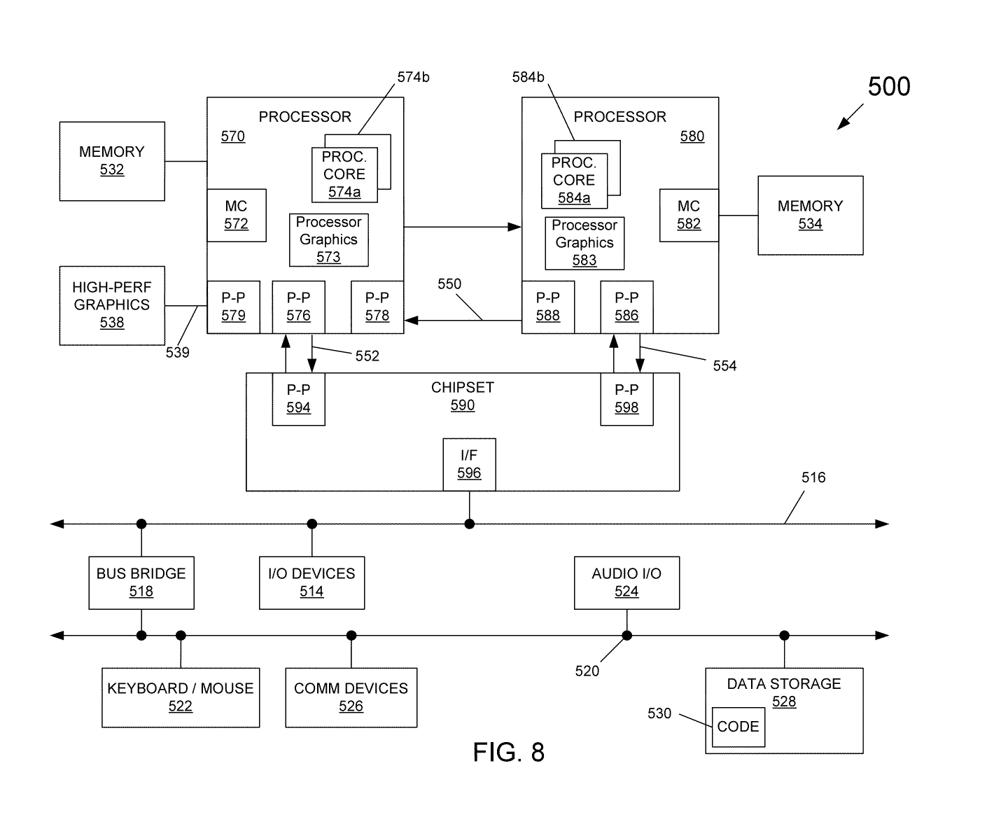

Embodiments may be implemented in many different system types. Referring now to FIG. 8, shown is a block diagram of a system in accordance with an embodiment of the present invention. As shown in FIG. 8, multiprocessor system 500 is a point-to-point interconnect system, and includes a first processor 570 and a second processor 580 coupled via a point-to-point interconnect 550. As shown in FIG. 8, each of processors 570 and 580 may be multicore processors, including first and second processor cores (i.e., processor cores 574a and 574b and processor cores 584a and 584b), although potentially many more cores may be present in the processors. Each of the processors can include a PCU or other logic to perform dynamic control of overclocking responsive to a user input during an OS environment, to enable higher system performance on the fly without a need for rebooting the system, as described herein.

Still referring to FIG. 8, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 8, MCH's 572 and 582 couple the processors to respective memories, namely a memory 532 and a memory 534, which may be portions of system memory (e.g., DRAM) locally attached to the respective processors. First processor 570 and second processor 580 may be coupled to a chipset 590 via P-P interconnects 552 and 554, respectively. As shown in FIG. 8, chipset 590 includes P-P interfaces 594 and 598.

Furthermore, chipset 590 includes an interface 592 to couple chipset 590 with a high performance graphics engine 538, by a P-P interconnect 539. In turn, chipset 590 may be coupled to a first bus 516 via an interface 596. As shown in FIG. 6, various input/output (I/O) devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520. Embodiments can be incorporated into other types of systems including mobile devices such as a smart cellular telephone, Ultrabook™, tablet computer, netbook, or so forth.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a plurality of cores each to independently execute instructions;
a plurality of graphics engines each to independently execute graphics operations; and
a power control unit (PCU) coupled to the plurality of cores and the plurality of graphics engines, the PCU including a first register having an overclock lock indicator which when set is to prevent a user from updating configuration settings associated with performance of the processor within an operating system (OS) environment.

2. The processor of claim 1, wherein the overclock lock indicator is settable during a pre-boot environment.

3. The processor of claim 1, wherein the overclock lock indicator is inaccessible to the user.

4. The processor of claim 1, wherein the PCU includes performance tuning update logic to access the overclock lock indicator of the first register and to enable the user to update one or more of the configuration settings within the OS environment when the overclock lock indicator is not set.

5. The processor of claim 4, wherein the PCU is to enable the user to update the one or more configuration settings via a software utility that executes in real-time within the OS environment.

6. The processor of claim 5, wherein the software utility is downloadable from a manufacturer of the processor or a platform provider.

7. The processor of claim 5, wherein the software utility is to provide a graphical user interface that includes selectable knobs to enable the user to update the one or more configuration settings.

8. The processor of claim 7, wherein the PCU is to update the one or more configuration settings responsive to the user update and without reset of a platform including the processor.

9. The processor of claim 1, wherein a first configuration setting corresponds to a core clock ratio, and when the overclock lock indicator is not set, the user is enabled to update the core clock ratio to a value greater than a maximum core clock ratio specified by a manufacturer of the processor.

10. An article comprising a machine-accessible medium including instructions that when executed cause a system to:
receive in a user-level application a user request to update a configuration setting associated with performance of a processor of the system, the request associated with an updated value for the configuration setting; and
communicate the updated value to a power control unit (PCU) of the processor via an operating system (OS) driver, wherein the PCU is to update the configuration setting to the updated value by storage of the updated value into a storage accessible to the PCU, the updated value to enable overclocking of the system.

11. The article of claim 10, further comprising instructions to present a graphical user interface (GUI) including a plurality of performance knobs, wherein the user is to control one of the plurality of performance knobs to provide the updated value.

12. The article of claim 11, further comprising instructions to receive a plurality of updated values each associated with one of the plurality of performance knobs, and to communicate the plurality of updated values to the PCU.

13. The article of claim 10, wherein the instructions are downloadable from a manufacturer of the processor as the user-level application.

14. The article of claim 10, wherein the user-level application is to execute within an operating system environment of the system.

15. The article of claim 10, further comprising instructions to:
receive in the user-level application a second user request to update a second configuration setting, the second configuration setting associated with a graphics engine of the processor, the second user request associated with a second updated value for the second configuration setting; and
communicate the second updated value to the PCU of the processor.

16. The article of claim 10, wherein the PCU is to determine whether the user is enabled to update the configuration setting, prior to storage of the updated value.

17. The article of claim 16, wherein the PCU is to access an overclock lock indicator of a first register to determine whether to enable the user update.

18. The article of claim 17, wherein the PCU is to store the updated value responsive to the overclock lock indicator being of a first state, and to cause a display of a message to the user that indicates that the user update is not enabled responsive to the overclock lock indicator being of a second state.

19. A system comprising:
a multicore processor including a plurality of cores, a plurality of graphics engines, and a power control unit (PCU) to control delivery of power to the plurality of cores and the plurality of graphics engines, wherein the PCU includes an overclocking control logic to receive a user request in an operating system (OS) environment to update at least one configuration setting to enable overclocking of the multicore processor and to determine whether to allow the update to occur; and
a dynamic random access memory (DRAM) coupled to the multicore processor.

20. The system of claim 19, wherein the multicore processor is to execute a tuning utility within the OS environment, wherein the tuning utility is to receive the user request and forward the user request to the PCU via an OS driver.

21. The system of claim 20, wherein a second system comprising a portable wireless device including a second tuning utility is to receive the user request from the user via an input device of the portable wireless device and forward the user request to the system via a wireless interface for communication to the tuning utility that executes on the multicore processor.

22. The system of claim 21, wherein the second tuning utility is to display one or more performance metrics of the multicore processor on a display of the portable wireless device, the one or more performance metrics received wirelessly from the system during execution of an application.
